(19) United States
(12) Patent Application Publication
(10) Pub. No.: US 2013/0312521 A1
(43) Pub. Date: Nov. 28, 2013

(54) CONTROL MODULE AND METHOD OF INERTIAL SENSOR

(71) Applicants: Kyung Rin Kim, Gyunggi-do (KR); Byoung Won Hwang, Gyunggi-do (KR); Chang Hyun Kim, Gyunggi-do (KR)

(72) Inventors: Kyung Rin Kim, Gyunggi-do (KR); Byoung Won Hwang, Gyunggi-do (KR); Chang Hyun Kim, Gyunggi-do (KR)

(73) Assignee: Samsung Electro-Mechanics Co., Ltd, Gyunggi-do (KR)

(21) Appl. No.: 13/554,855

(22) Filed: Jul. 20, 2012

(30) Foreign Application Priority Data
May 25, 2012 (KR) 10-2012-0056066

(51) Int. Cl. G01P 3/04

(52) U.S. Cl. 73/510

(57) ABSTRACT

Disclosed herein is a control module of an inertial sensor, including: at least one inertial sensor including a driving mass; a sensing unit detecting and transferring information of the inertial sensor; a multiplexer unit including at least one multiplexer to selectively transfer the information of the inertial sensor to a sampling unit or a filter unit according to whether before or after start-up of the inertial sensor; a controlling unit including automatic gain control (AGC) and connected to the sampling unit and the filter unit to generate control information including an AGC gain for the inertial sensor; and a driving unit applying the AGC gain to the inertial sensor according to the control information, wherein the sampling unit and the filter unit are connected to each other so as to interwork with each other.

### CROSS REFERENCE TO RELATED APPLICATION

This application claims the benefit of Korean Patent Application No. 10-2012-0056066, filed on May 25, 2012, entitled “Driving-control Module and Method for Inertial Sensor”, which is hereby incorporated by reference in its entirety into this application.

### BACKGROUND OF THE INVENTION

1. Technical Field

The present invention relates to a control module and method of an inertial sensor.

2. Description of the Related Art

Recently, an inertial sensor has been used in various applications, for example, a military application such as an artificial satellite, a missile, an unmanned aircraft, or the like, an air bag, electronic stability control (ESC), a black box for a vehicle, hand shaking prevention of a camcorder, motion sensing of a mobile phone or a game machine, navigation, and the like.

The inertial sensor is divided into an acceleration sensor capable of measuring linear movement and an angular velocity sensor capable of measuring rotational movement.

Acceleration may be calculated by an equation regarding Newton's law of motion: “F=ma”, where “m” is a mass of a moving object, and “a” is acceleration to be measured. Angular velocity may be calculated by an equation regarding Coriolis force “F=2mΩ×v”, where “m” represents the mass of the moving object, “Ω” represents the angular velocity to be measured, and “v” represents the motion velocity of the mass. In addition, a direction of the Coriolis force is determined by a velocity (v) axis and a rotational axis of angular velocity (Ω).

This inertial sensor may be divided into a ceramic sensor and a microelectromechanical systems (MEMS) sensor according to a manufacturing process thereof. Here, the MEMS sensor divided into a capacitive type sensor, a piezoresistive type sensor, a piezoelectric type sensor, and the like, according to the sensing principle.

Particularly, as it becomes easy to manufacture a small-sized and light MEMS sensor using an MEMS technology as described in Korean Patent Laid-Open Publication No. 2011-0072229, a function of an inertial sensor has also been continuously developed.

For example, the function and performance of the inertial sensor have been improved from a uniaxial sensor capable of detecting only inertial force for a single axis using a single sensor to a multi-axis sensor capable of detecting inertial force for a multi-axis of two axes or more using a single sensor.

As described above, in order to implement a six-axis sensor detecting the multi-axis inertial forces, that is, three-axis acceleration and three-axis angular velocity using the single sensor, accurate and effective driving and control are required.

In the case of the inertial sensor according to the prior art, since a time in which a driving mass is stably driven may not be accurately recognized, a driving time and a sensing time should be set in consideration of a value of an error range or more.

Further, in the case in which the driving mass is designed to have various sizes and forms, the driving time and the sensing time of the inertial sensor may not be collectively set. Particularly, since each of the control times should be set in consideration of an error range or more, productivity is deteriorated and efficient control of the driving and the sensing is not performed.

### SUMMARY OF THE INVENTION

The present invention has been made in an effort to provide a control module of an inertial sensor capable of performing accurate and effective driving and control using automatic gain control (AGC).

Further, the present invention has been made in an effort to provide a control method capable of accurately and effectively driving and controlling an inertial sensor using AGC.

According to a preferred embodiment of the present invention, there is provided a control module of an inertial sensor, including: at least one inertial sensor including a driving mass; a sensing unit detecting and transferring information of the inertial sensor; a multiplexer unit including at least one multiplexer to selectively transfer the information of the inertial sensor to a sampling unit or a filter unit according to whether before or after start-up of the inertial sensor; a controlling unit including automatic gain control (AGC) and connected to the sampling unit and the filter unit to generate control information including an AGC gain for the inertial sensor; and a driving unit applying the AGC gain to the inertial sensor according to the control information, wherein the sampling unit and the filter unit are connected to each other so as to interwork with each other.

The control module may further include an analog to digital (A/D) converter provided between the sensing unit and the multiplexer unit, wherein the A/D converter digitizes and transfers the information of the inertial sensor.

The control module may further include a digital to analog (D/A) converter provided between the controlling unit and the driving unit.

The information of the inertial sensor may include information on whether or not the inertial sensor is in an initial start-up state, information on whether or not the driving mass is in a stabilized state, information on inertial force in the inertial sensor, and information on an amplitude peak of the driving mass.

The sampling unit may down-sample the information of the inertial sensor in consideration of a mass response time of the inertial sensor.

The filter unit may include a digital low pass filter and remove noise included in the information of the inertial sensor to filter the information of the inertial sensor into information having a cutoff frequency close to direct current (DC).

According to another preferred embodiment of the present invention, there is provided a control method of an inertial sensor, including: detecting information of the inertial sensor through a sensing unit; receiving, in a multiplexer unit, information on whether or not the inertial sensor is during start-up from the sensing unit and transferring resonant information of the inertial sensor included in the information of the inertial sensor to a sampling unit and a filter unit; performing, in a controlling unit, an AGC operation for generating an AGC gain according to the resonant information of the inertial sensor processed in the sampling unit or the filter unit; and applying, in a driving unit, the AGC gain to the inertial sensor.

The transferring of the resonant information to the sampling unit and the filter unit may include: transferring, in the multiplexer unit, the resonant information of the inertial sensor to the filter unit according to information indicating that the inertial sensor is during the start-up, thereby filtering the resonant information of the inertial sensor; transferring the filtered resonant information of the inertial sensor to the sampling unit, thereby down-sampling the filtered resonant information of the inertial sensor.

The transferring of the resonant information to the sampling unit and the filter unit may include: transferring, in the multiplexer unit, the resonant information of the inertial sensor to the sampling unit according to information indicating that the inertial sensor is after the start-up, thereby down-sampling the resonant information of the inertial sensor; and transferring the down-sampled resonant information of the inertial sensor to the filter unit, thereby filtering the down-sampled resonant information of the inertial sensor.

The information of the inertial sensor may include information on whether or not the inertial sensor is in an initial start-up state, information on whether or not the driving mass is in a stabilized state, information on inertial force in the inertial sensor, and information on an amplitude peak of the driving mass.

The transferring of the resonant information to the sampling unit and the filter unit may further include digitalizing, in an A/D converter positioned between the sensing unit and the multiplexer unit, the information of the inertial sensor to transfer the digitalized information to the multiplexer unit.

The applying of the AGC gain to the inertial sensor may include digitizing, in a D/A converter positioned between the controlling unit and the driving unit, the AGC gain to apply the digitalized AGC gain to the inertial sensor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a control module of an inertial sensor according to a preferred embodiment of the present invention;

FIG. 2 is a flow chart describing a control method of an inertial sensor according to another preferred embodiment of the present invention;

FIG. 3 is a view describing a control method during start-up of the inertial sensor according to another preferred embodiment of the present invention; and

FIG. 4 is a view describing a control method after the start-up of the inertial sensor according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

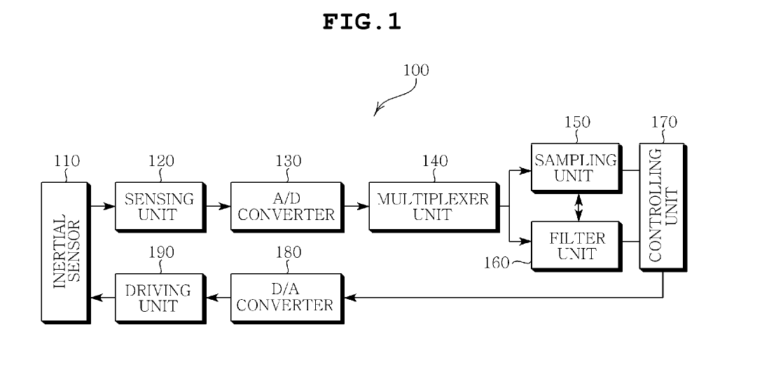

FIG. 1 is a block diagram of a control module of an inertial sensor according to a preferred embodiment of the present invention.

The control module 100 of an inertial sensor according to the preferred embodiment of the present invention is configured to include an inertial sensor 110, a sensing unit 120, an analog to digital (A/D) converter 130, a multiplexer unit 140, a sampling unit 150, a filter unit 160, a controlling unit 170, a digital to analog (D/A) converter 180, and a driving unit 190.

The inertial sensor 110 may include an acceleration sensor capable of detecting three axial accelerations positioned on a space by including a driving mass or an angular velocity sensor capable of detecting three axial angular velocities. This inertial sensor 110 generates a signal corresponding to motion such as movement and rotation and transfers the generated signal to the sensing unit 120.

The sensing unit 120 detects information of the inertial sensor 110 including information on whether or not the inertial sensor 110 is in an initial start-up state, information on whether or not the driving mass is in a stabilized state, information on inertial force in the inertial sensor 110, and information on an amplitude peak of the driving mass to transfer the detected information to the analog to digital converter 130.

The multiplexer unit 140 includes at least one multiplexer to selectively transfer the information of the inertial sensor 110 digitized and transferred from the analog to digital converter 130 according to whether before or after the start-up of the inertial sensor 110 to the sampling unit 150 or the filter unit 160.

Specifically, the reason why the multiplexer unit 140 selectively transfers the information of the inertial sensor 110 separately before and after the start-up of the inertial sensor 110 is to reduce a stabilization time for correcting a resonant peak value of the inertial sensor 110 into a target value before the start-up of the inertial sensor 110 and stably perform automatic gain control (AGC) processing for the resonant peak value of the inertial sensor 110 to the target value after the start-up of the inertial sensor 110.

Particularly, a sensor start-up time for stably driving the inertial sensor 110 initially is one of very important items among many evaluation items for performance of the inertial sensor 110. It may be judged that the shorter the sensing start-up time, the higher the performance of the inertial sensor 110.

Therefore, it is important to achieve the stabilization of the driving mass in a shorter time by applying a rapid AGC gain during the start-up of the inertial sensor 110.

On the other hand, it is important to allow the resonant value of the inertial sensor 110 to converge so as to be as close as possible to the target resonant value by applying an AGC gain having a value more accurate than an operation speed of the AGC after the start-up of the inertial sensor 110.

Therefore, the multiplexer unit 140 selectively transfers the information of the inertial sensor 110 to the sampling unit 150 or the filter unit 160 according to whether before and after the start-up of the inertial sensor 110.

The sampling unit 150 down-samples the received information of the inertial sensor 110 in consideration of a mass response time of the inertial sensor 110.

Specifically, the resonant information of the inertial sensor 110 is applied from the analog to digital converter 130 at a predetermined sampling interval according to a preset value. In addition, the mass of the inertial sensor 110 has a mass response time which is a time required to apply the AGC gain to stabilize the mass. Generally, the mass response time is several times or several tens of times longer than a data sampling rate time.

Therefore, in order to process the resonant peak information of the inertial sensor 110 in consideration of the mass response time, it is required for the sampling unit 150 to down-sample the resonant peak information of the inertial sensor 110 at a predetermined interval.

A time required for the AGC gain to be generated and applied to the inertial sensor 110 becomes longer than the mass response time through this down-sampling process, such that the AGC gain may be stably applied to the mass of the inertial sensor 110.

The filter unit 160 includes, for example, a digital low pass filter filtering noise included in the received information of the inertial sensor 110. The filter unit 160 removes the noise generated in an information processing process even though the resonant information of the inertial sensor 110 transferred from the analog to digital converter 130 is applied in a direct current (DC) form, thereby filtering the resonant information into resonant information having a cutoff frequency close to DC.

The resonant information filtered into the resonant information close to the DC as described above is transferred to the controlling unit 170, which performs an AGC operation for generating the AGC gain for the inertial sensor 110 according to the filtered resonant information.

In addition, the filter unit 160 also has a function capable of reducing a change speed of the resonant information, thereby making it possible to increase stability of the control module 100 of an inertial sensor 110.

The controlling unit 170 generates the AGC gain for resonating the received mass resonant value of the inertial sensor 110 including the AGC into the target resonant value and transfers information on the generated AGC gain to the driving unit 190 through the digital to analog converter 180.

Particularly, the controlling unit 170 is provided as a digital circuit of a PID controller logic, thereby making it possible to allow the mass resonant value of the inertial sensor 110 to maximally stably and rapidly converge into the target resonant value.

The control module 100 of the inertial sensor according to the preferred embodiment of the present invention configured as described above has a path for selectively transferring the information of the inertial sensor 110 to the sampling unit 150 or the filter unit 160 according to whether before and after the start-up of the inertial sensor 110, thereby making it possible to efficiently apply the AGC gain to the inertial sensor 110.

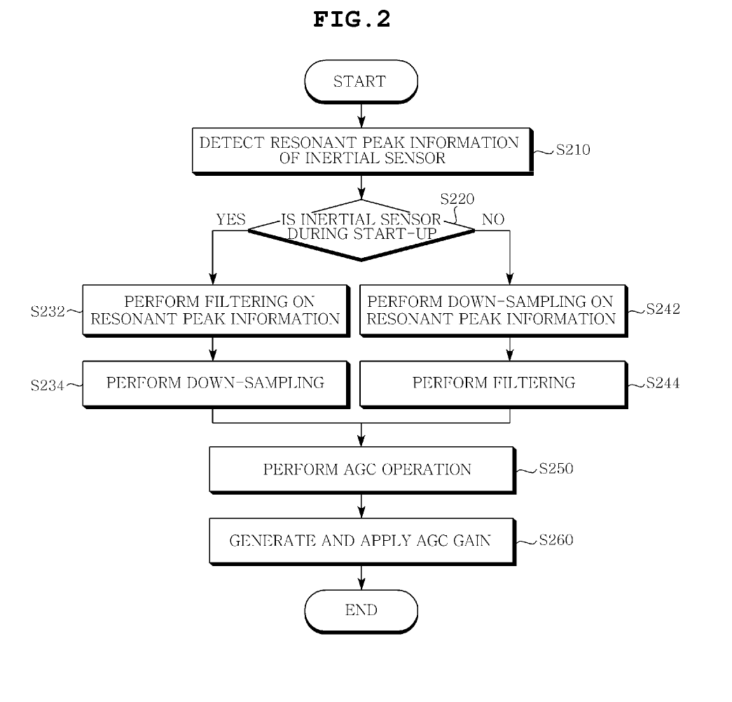

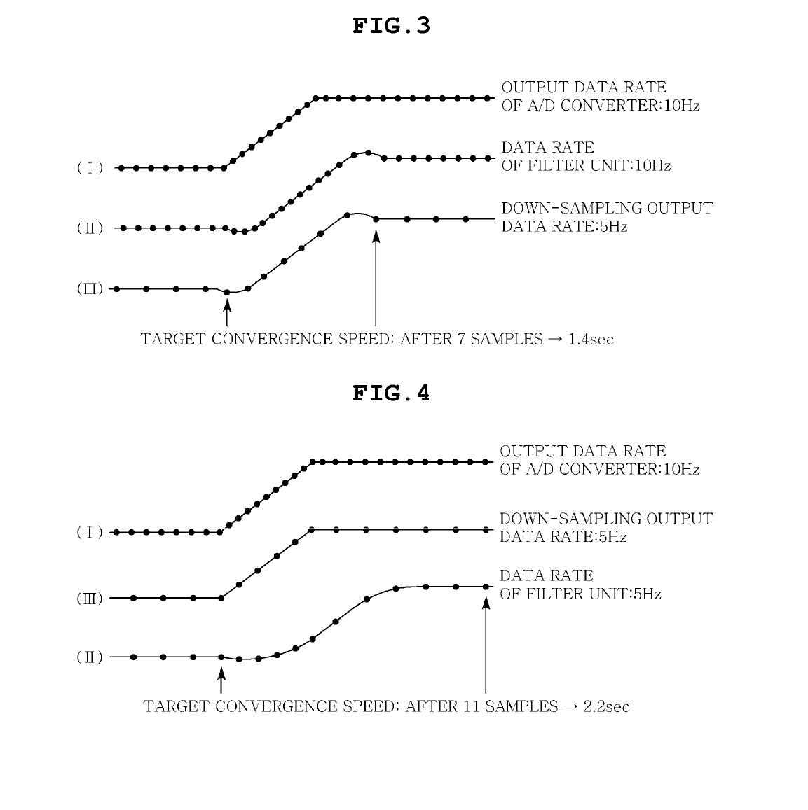

Hereinafter, a control method of an inertial sensor according to another preferred embodiment of the present invention will be described with reference to FIGS. 2 to 4. FIG. 2 is a flow chart describing a control method of an inertial sensor according to another preferred embodiment of the present invention; FIG. 3 is a view describing a control method during start-up of the inertial sensor according to another preferred embodiment of the present invention; and FIG. 4 is a view describing a control method after the start-up of the inertial sensor according to another preferred embodiment of the present invention.

As shown in FIG. 2, in the control method of an inertial sensor 110 according to another preferred embodiment of the present invention, resonant information including an amplitude peak value of a driving mass driven in the inertial sensor 110 is first detected through the sensing unit 120 (S210).

The resonant information detected as described above is analog information including information on whether or not the inertial sensor 110 is in an initial start-up state, information on whether or not the driving mass is in a stabilized state, information on inertial force in the inertial sensor 110, and information on the amplitude peak of the driving mass and is digitized in the analog to digital converter 130 and then transferred to the multiplexer unit 140.

Here, the multiplexer unit 140 receives the information on whether the inertial sensor 110 is during start-up from the sensing unit 120 through the analog to digital converter 130 to transfer the received resonant peak information to the sampling unit 150 or the filter unit 160 according to the information on whether the inertial sensor 110 is during the start-up (S220).

Here, the multiplexer unit 140 transfers the received resonance peak information to the filter unit 160 according to information indicating that the inertial sensor 110 is in a start-up process, thereby performing low pass filtering (S232). Then, down-sampling is applied in the sampling unit 150 (S234).

That is, during the start-up process of the inertial sensor 110, since the multiplexer unit 140 selects a path through which the resonant peak information is transferred to the sampling unit 150 through the filter unit 160 and the controlling unit 170 performs the AGC operation, the driving mass of the inertial sensor 110 may be stabilized in a shorter time.

Therefore, as shown in FIG. 3, a cutoff frequency (See a graph of II) regarding a data rate output from the filter unit 160 acts so as to depend only on an input data sampling rate of the sampling unit 150, such that it is difficult to expect a better filtering effect. However, as shown in a graph of III, a convergence time required for the resonant value to be stabilized into the target value may be 1.4 second by the AGC operation processing capable of instantaneously reacting to a resonant change amount of the inertial sensor 110.

On the other hand, after the start-up of the inertial sensor 110, the multiplexer unit 140 transfers the received resonant peak information to the sampling unit 150 according to information indicating that the inertial sensor 110 is in a process after the start-up, thereby performing down-sampling (S242). Then, low pass filtering is performed in filter unit 160 (S244).

That is, after the start-up of the inertial sensor 110, since the multiplexer unit 140 selects a path through which the resonant peak information is transferred to the filter unit 160 through the sampling unit 150 and the controlling unit 170 performs the AGC operation, the controlling unit 170 generates and applies an AGC gain having a more accurate value, thereby making it possible to allow the resonant value of the inertial sensor 110 to converge so as to be as close as possible to the target resonant value.

Therefore, as shown in FIG. 4, stable application of the AGC gain is improved and a down-sampled sampling rate (See a graph of III) is applied to the filter unit 160, such that a convergence time is longer than that of FIG. 3 as shown in a graph of II. However, a cutoff frequency regarding the data rate output from the filter unit 160 may become closer to DC as compared to the input data sampling rate.

Therefore, the controlling unit 170 more precisely performs the AGC operation and applies the AGC gain to the inertial sensor 110, thereby making it possible to allow the resonant value of the inertial sensor 110 to be stabilized into the target resonant value.

Then, the controlling unit 170 receives the processed resonant peak information from each path to perform the AGC operation for applying the AGC gain to the driving mass of the inertial sensor 110 (S250).

When the controlling unit 170 performs the AGC operation to calculate the AGC gain, the controlling unit 170 generates the AGC gain to apply the AGC gain to the inertial sensor 110 through the digital to analog converter 180 and the driving unit 190 (S260).

In the control method of an inertial sensor 110 according to another preferred embodiment of the present invention performed as described above, the down-sampling is applied in consideration of the mass response time of the inertial sensor 110 and a path is selected separately before and after the inertial sensor 110. That is, the pass is selected so that the driving mass of the inertial sensor 110 may be stabilized in a shorter time during the start-up process of the inertial sensor 110 and is selected so that the AGC gain having a more accurate value may be generated to allow the resonant value of the inertial sensor 110 to converge so as to be as close as possible to the target resonant value after the start-up of the inertial sensor 110.

Therefore, in the control method of an inertial sensor 110 according to another preferred embodiment of the present invention, the AGC operation is performed and the AGC gain is applied, according to whether before or after the start-up of the inertial sensor 110, thereby making it possible to accurately and effectively drive and control the inertial sensor 110 using the AGC.

As set forth above, the control module of an inertial sensor according to the preferred embodiment of the present invention has a path through which the information of the inertial sensor is selectively transferred to the sampling unit or the filter unit according to whether before or after the start-up of the inertial sensor, thereby making it possible to efficiently apply the AGC gain to the inertial sensor.

In the control method of an inertial sensor according to the preferred embodiment of the present invention, the AGC operation is performed and the AGC gain is applied, according to whether before or after the start-up of the inertial sensor, thereby making it possible to accurately and effectively drive and control the inertial sensor using the AGC.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A control module of an inertial sensor, comprising:
at least one inertial sensor including a driving mass;
a sensing unit detecting and transferring information of the inertial sensor;
a multiplexer unit including at least one multiplexer to selectively transfer the information of the inertial sensor to a sampling unit or a filter unit according to whether before or after start-up of the inertial sensor;
a controlling unit including automatic gain control (AGC) and connected to the sampling unit and the filter unit to generate control information including an AGC gain for the inertial sensor; and
a driving unit applying the AGC gain to the inertial sensor according to the control information,
wherein the sampling unit and the filter unit are connected to each other so as to interwork with each other.

2. The control module as set forth in claim 1, further comprising an analog to digital (A/D) converter provided between the sensing unit and the multiplexer unit, wherein the A/D converter digitizes and transfers the information of the inertial sensor.

3. The control module as set forth in claim 1, further comprising a digital to analog (D/A) converter provided between the controlling unit and the driving unit.

4. The control module as set forth in claim 1, wherein the information of the inertial sensor includes information on whether or not the inertial sensor is in an initial start-up state, information on whether or not the driving mass is in a stabilized state, information on inertial force in the inertial sensor, and information on an amplitude peak of the driving mass.

5. The control module as set forth in claim 1, wherein the sampling unit down-samples the information of the inertial sensor in consideration of a mass response time of the inertial sensor.

6. The control module as set forth in claim 1, wherein the filter unit includes a digital low pass filter and removes noise included in the information of the inertial sensor to filter the information of the inertial sensor into information having a cutoff frequency close to direct current (DC).

7. A control method of an inertial sensor, comprising:
detecting information of the inertial sensor through a sensing unit;
receiving, in a multiplexer unit, information on whether or not the inertial sensor is during start-up from the sensing unit and transferring resonant information of the inertial sensor included in the information of the inertial sensor to a sampling unit and a filter unit;
performing, in a controlling unit, an AGC operation for generating an AGC gain according to the resonant information of the inertial sensor processed in the sampling unit or the filter unit; and
applying, in a driving unit, the AGC gain to the inertial sensor.

8. The control method as set forth in claim 7, wherein the transferring of the resonant information to the sampling unit and the filter unit includes:
transferring, in the multiplexer unit, the resonant information of the inertial sensor to the filter unit according to information indicating that the inertial sensor is during the start-up, thereby filtering the resonant information of the inertial sensor; and
transferring the filtered resonant information of the inertial sensor to the sampling unit, thereby down-sampling the filtered resonant information of the inertial sensor.

9. The control method as set forth in claim 7, wherein the transferring of the resonant information to the sampling unit and the filter unit includes: transferring, in the multiplexer unit, the resonant information of the inertial sensor to the sampling unit according to information indicating that the inertial sensor is after the start-up, thereby down-sampling the resonant information of the inertial sensor; and
transferring the down-sampled resonant information of the inertial sensor to the filter unit, thereby filtering the down-sampled resonant information of the inertial sensor.

10. The control method as set forth in claim 7, wherein the information of the inertial sensor includes information on whether or not the inertial sensor is in an initial start-up state, information on whether or not the driving mass is in a stabilized state, information on inertial force in the inertial sensor, and information on an amplitude peak of the driving mass.

11. The control method as set forth in claim 7, wherein the transferring of the resonant information to the sampling unit and the filter unit further includes digitalizing, in an A/D converter positioned between the sensing unit and the multiplexer unit, the information of the inertial sensor to transfer the digitalized information to the multiplexer unit.

12. The control method as set forth in claim 7, wherein the applying of the AGC gain to the inertial sensor includes digitizing, in a D/A converter positioned between the controlling unit and the driving unit, the AGC gain to apply the digitalized AGC gain to the inertial sensor.
